(19) United States
(12) Patent Application Publication
(10) Pub. No.: US 2015/0302352 A1
(43) Pub. Date: Oct. 22, 2015

(54) KNOWLEDGE PROXIMITY DETECTOR

(71) Applicant: Chegg, Inc., Santa Clara, CA (US)

(72) Inventors: Vincent Le Chevalier, San Jose, CA (US); Diego de Pinho Mendes, Mountain View, CA (US); Charles F. Geiger, San Jose, CA (US)

(73) Assignee: Chegg, Inc., Santa Clara, CA (US)

(21) Appl. No.: 14/254,721

(22) Filed: Apr. 16, 2014

(51) Int. Cl. G06Q 10/10; G06Q 50/20

(52) U.S. Cl. CPC G06Q 10/10; G06Q 50/2053

(57) ABSTRACT

An online education platform matches users for academic assistance events. The education platform receives offers for academic assistance events from providers, each of whom has accessed one or more textbook solutions documents. The education platform captures a time-sensitive request for an academic assistance event from a seeker. The request is associated with a textbook solutions document. Based on the textbook solutions document associated with the requested event and the textbook solutions documents accessed by the providers, the education platform pairs the requested event to at least one offered event. During a time window of the at least one offered event, the education platform detects proximity of the seeker and the provider and notifies the seeker and provider of the detected proximity. The education platform connects the seeker and provider, enabling communication between the users.

### BACKGROUND

1. Field of the Invention

This invention relates to matching users fur academic assistance events by an online education platform.

2. Description of the Related Art

The successful deployment of electronic textbooks and educational materials by education publishing platforms has introduced multiple alternatives to the traditional print textbook marketplace. By integrating new and compelling digital education services into core academic material, these publishing platforms provide students and instructors with access to a wide range of collaborative tools and solutions that are rapidly changing the way courses are constructed and delivered

As traditional courses are shifting from a static textbook-centric model to a connected one where related, personalized and other social-based content activities are being aggregated dynamically within the core academic material, it becomes strategic for education publishing platforms to be able to support students not only during their reading activities, but also during other phases of their daily learning activities. In particular, these platforms currently do not provide a way for students to receive academic assistance outside the traditional rigid course instructional framework.

### SUMMARY

An online education platform matches users for in-person academic assistance events. Users of the education platform who are willing to provide assistance with textbook solutions (referred to as “providers”) send offers for academic assistance events to the education platform. Users of the education platform who are seeking assistance with textbook solutions (referred to as “seekers”) send requests for academic assistance events to the education platform. The education platform pairs each of the requested events to one or more offered events based on the textbook solutions associated with the requested event and the textbook solutions the providers have accessed. In one embodiment, the education platform also uses other attributes of the requested and offered events to pair the events. A requested event and offered event paired to one another are scheduled for an event window corresponding to an overlap between a time window of the requested event and a time window of the offered event.

During the event window corresponding to the paired events, the education platform identifies locations of the seeker and provider corresponding to the paired events. If the seeker and provider are determined to be in proximity to one another, the education platform notifies the seeker and provider and requests confirmation of the academic assistance event. If the seeker and provider confirm the event, the education platform enables communication between the seeker and provider. For example, the seeker and provider can communicate through the education platform to arrange a time and location to meet, where the provider can provide the seeker with assistance with the textbook solutions.

The features and advantages described in this summary and the following detailed description are not all-inclusive. Many additional features and advantages will be apparent to one of ordinary skill M the art in view of the drawings, specification, and claims.

### BRIEF DESCRIPTION OF THE DRAWINGS

FIG. 1 illustrates an example education platform, according to one embodiment.

FIG. 2 is a block diagram illustrating interactions with an education platform, according to one embodiment.

FIG. 3 illustrates a document reconstruction process, according to one embodiment.

FIG. 4 illustrates a textbook solutions distribution model, according to one embodiment.

FIG. 5 is a block diagram illustrating modules within the education platform 500, according to one embodiment.

FIG. 6 is an interaction diagram illustrating a process for matching users for academic assistance events, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

Embodiments will be described in the context of a versatile education social learning platform for digital content interactive services distribution and consumption. In the platform, personalized learning services are paired with secured distribution and analytics systems for reporting on both connected user activities and effectiveness of deployed services. The education platform manages educational services through the organization, distribution, and analysis of electronic documents.

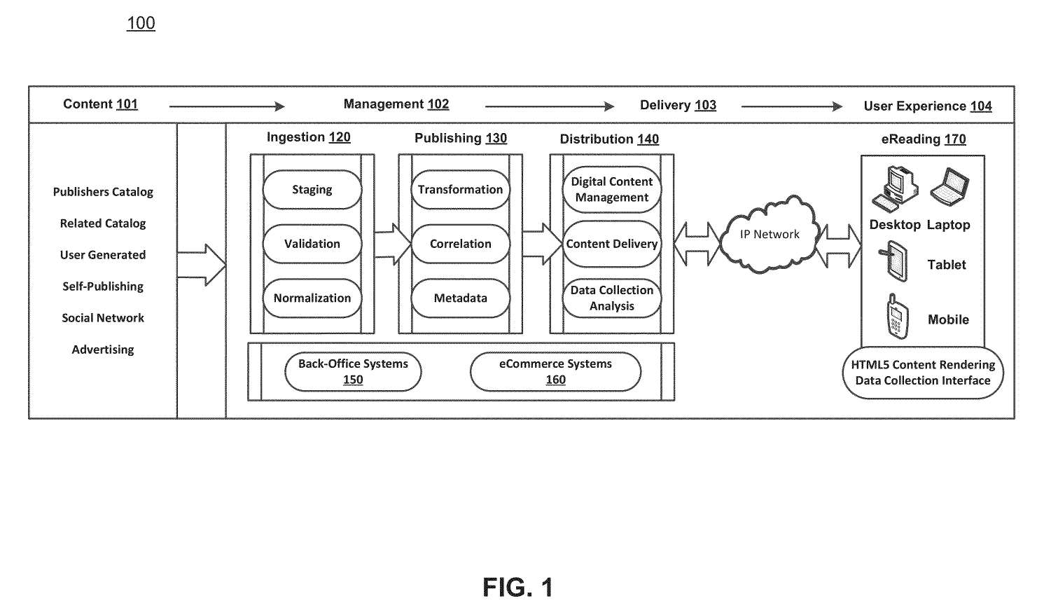

FIG. 1 is a high-level block diagram illustrating the education platform environment 100. The education platform. environment 100 is organized around four function blocks: content 101, management 102, delivery 103, and experience 104.

Content block 101 automatically gathers and aggregates content from a large number of sources, categories, and partners. Whether the content is curated, perishable, on-line, or personal, these systems define the interfaces and processes to automatically collect various content sources into a formalized staging environment.

Management block 102 comprises five blocks with respective submodules: ingestion 120, publishing 130, distribution 140, back office system 150, and eCommerce system 160. The ingestion module 120, including staging, validation, and normalization subsystems, ingests published. documents that may be in a variety of different formats, such as PDF, ePUB2, ePUB3, SVG, XML, or HTML. The ingested document may be a book, such as a textbook, a set of self-published notes, or any other published document, and may be subdivided in any manner. For example, the document may have a plurality of pages organized into chapters, which could be further divided into one or more sub-chapters. Each page may have text, images, tables, graphs, or other items distributed across the page.

After ingestion, the documents are passed to the publishing system 130, which in one embodiment induct s transformation, correlation, and metadata subsystems. If the document ingested by the ingestion module 120 is not in a markup language format, the publishing system 130 automatically identifies, extracts, and indexes all the key elements and composition of the document to reconstruct it into a modern, flexible, and interactive HTML5 format. The ingested documents are converted into markup language documents well-suited for distribution across various computing devices. In one embodiment, the publishing system 130 reconstructs published documents so as to accommodate dynamic add-ons, such as user-generated and related content, while maintaining page fidelity o the original document. The transformed content preserves the original page structure including pagination, number of columns and arrangement of paragraphs, placement and appearance of graphics, titles and captions, and fonts used, regardless of the original format of the source content and complexity of the layout of the original document.

The page structure information is assembled into a document-specific table of contents describing locations of chapter headings and sub-chapter headings within the reconstructed document, as well as locations of content within each heading. During reconstruction, document metadata describing a product description, pricing, and terms (e.g., whether the content is for sale, rent, or subscription, or whether it is accessible for a certain time period or geographic region, etc.) are also added to the reconstructed document.

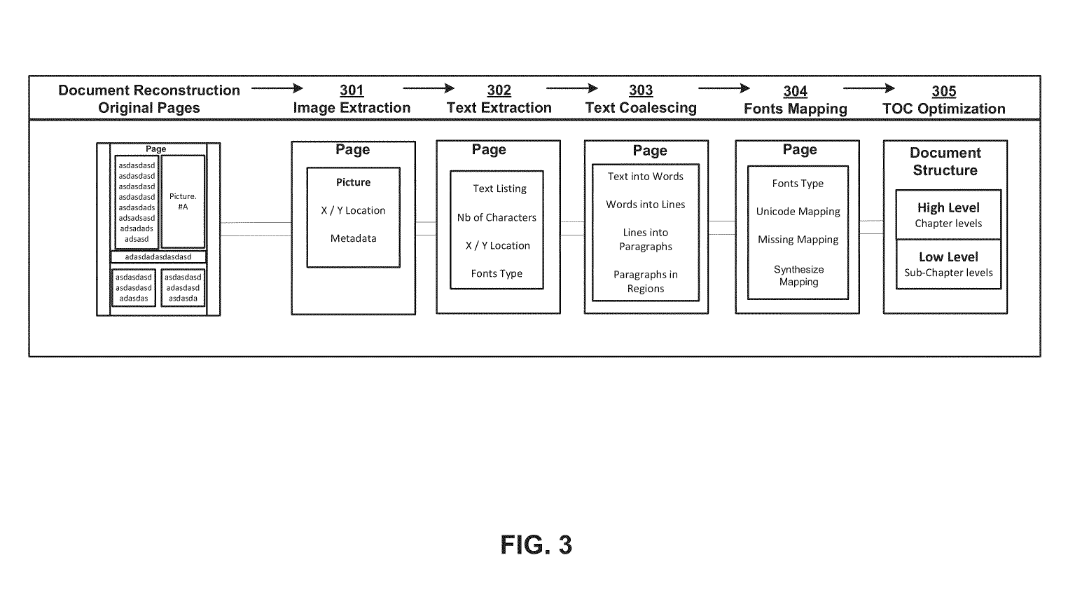

The reconstructed document's table of contents indexes the content of the document into a description of the overall structure of the document, including chapter headings and sub-chapter headings. Within each heading, the table of contents identifies the structure of each page. As content is added dynamically to the reconstructed document, the content is indexed and added to the table of contents to maintain a current representation of the document's structure. The process performed by the publishing system 130 to reconstruct a document and generate a table of contents is described further with respect to FIG. 3.

The distribution system 140 packages content for delivery, uploads the content to content distribution networks, and makes the content available to end users based on the content's digital rights management policies. In one embodiment, the distribution system 140 includes digital content management, content delivery, and data collection and analysis subsystems.

Whether the ingested document is in a markup language document or is reconstructed by the publishing system 130, the distribution system 140 may aggregate additional content layers from numerous sources into the ingested or reconstructed document. These layers, including related content, advertising content, social content, and user-generated content, may be added to the document to create a dynamic, multilayered document. For example, related content may comprise material supplementing the foundation document, such as study guides, textbook solutions, self-testing material, solutions manuals, glossaries, or journal articles. Advertising content may be uploaded by advertisers or advertising agencies to the publishing platform, s that advertising content may be displayed with the document. Social content may be uploaded to the publishing platform by the user or by other nodes (e.g., classmates, teachers, authors, etc.) in the user's social graph. Examples of social content include interactions between users related to the document and content shared by members of the user's social graph. User-generated content includes annotations made by a user during an eReading session, such as highlighting or taking notes. In one embodiment, user-generated content may be self-published by a user and made available to other users as a related content layer associated with a document or as a standalone document.

As layers are added to the document, page information and metadata of the document are referenced by all layers to merge the multilayered document into a single reading experience. The publishing system 130 may also add information describing the supplemental layers to the reconstructed document's table of contents. Because the page-based document ingested into the management block 102 or the reconstructed document generated by the publishing system 130 is referenced by all associated content layers, the ingested or reconstructed document is referred to herein as a “foundation document,” while the “multi layered document” refers to a foundation document and the additional content layers associated with the foundation document.

The back-office system 150 of management block 102 enables business processes such as human resources tasks, sales and marketing, customer and client interactions, and technical support. The eCommerce system 160 interfaces with back office system 150, publishing 130, and distribution 140 to integrate marketing, selling, servicing, and receiving payment for digital products and services.

Delivery block 103 of an educational digital publication and reading platform distributes content for user consumption by, for example, pushing content to edge servers on a content delivery network. Experience block 104 manages user interaction with the publishing platform through browser application 170 by updating content, reporting users' reading and other educational activities to be recorded by the platform, and assessing network performance.

In the example illustrated in FIG. 1, the content distribution and protection system is interfaced directly between the distribution sub-system 140 and the browser application 170, essentially integrating the digital content management (DCM), content delivery network (CDN), delivery modules, and eReading data collection interface for capturing and serving all users' content requests. By having content served dynamically and mostly on-demand, the content distribution and protection system effectively authorizes the download of one page of content at a time through time-sensitive dedicated URLs which only stay valid for a limited time, for example a few minutes in one embodiment, all under control of the platform service provider.

### Platform Content Processing and Distribution

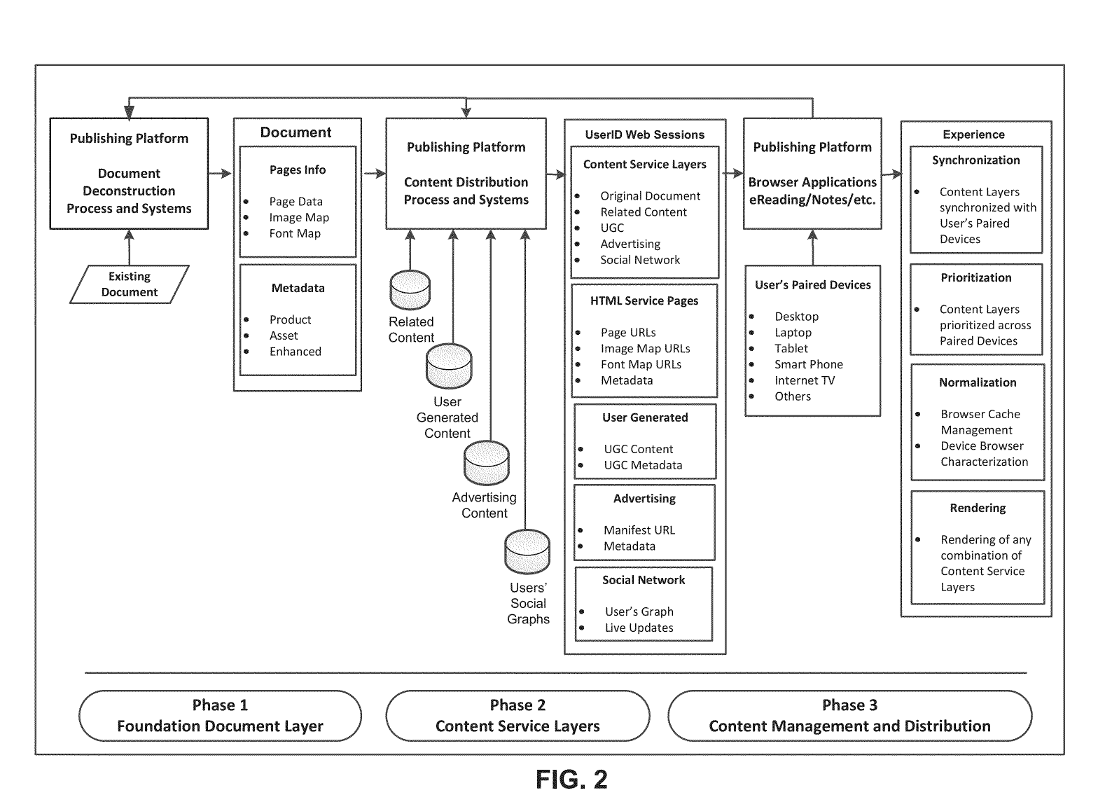

The platform content catalog is a mosaic of multiple content sources which are collectively processed and assembled into the overall content service offering. The content catalog is based upon multilayered publications that are created from reconstructed foundation documents augmented by supplemental content material resulting from users' activities and platform back-end processes. FIG. 2 illustrates an example of a publishing platform where multilayered content document services are assembled and distributed to desktop, mobile, tablet, and other connected devices. As illustrated in FIG. 2, the process is typically segmented into three phases: Phase 1: creation of the foundation document layer; Phase 2: association of the content service layers to the foundation document layer; and Phase 3: management and distribution of the content.

During Phase 1, the licensed document is ingested into the publishing platform and automatically reconstructed into a series of basic elements, while maintaining page fidelity to the original document structure. Document reconstruction will be described in more detail below with reference to FIG. 3.

During Phase 2, once a foundation document has been reconstructed and its various elements extracted, the publishing platform runs several processes to enhance the reconstructed document and transform it into a personalized multilayered content experience. For instance, several distinct processes are run to identify the related content to the reconstructed document, user generated content created by registered users accessing the reconstructed document, advertising or merchandising material that can be identified by the platform and indexed within the foundation document and its layers, and social network content resulting from registered users' activities. By having each of these processes focusing on specific classes of content and databases, the elements referenced within each classes become identified by their respective content layer. Specifically, all the related content page-based elements that are matched with a particular reconstructed document are classified as part of the related content layer. Similarly, all other document enhancement processes, including user generated, advertising and social among others, are classified by their specific content layer. The outcome of Phase 2 is a series of static and dynamic page-based content layers that are logically stacked on top of each other and which collectively enhance the reconstructed foundation document.

During Phase 3, once the various content layers have been identified and processed, the resulting multilayered documents are then published to the platform content catalog and pushed to the content servers and distribution network for distribution. By having multilayered content services served dynamically and on-demand through secured authenticated web sessions, the content distribution systems are effectively authorizing and directing the real-time download of page-based layered content services to a user's connected devices. These devices access the services through time sensitive dedicated URLs which, in one embodiment, only stay valid for a few minutes, all under control of the platform service provider. The browser-based applications are embedded, for example, into HTML5 compliant web browsers which control the fetching, requesting, synchronization, prioritization, normalization and rendering of all available content services.

### Document Reconstruction

The publishing system 130 receives original documents for reconstruction from the ingestion system 120 illustrated in FIG. 1. In one embodiment, a series of modules of the publishing system 130 are configured to perform the document reconstruction process.

FIG. 3 illustrates a process within the publishing system 130 for reconstructing a document. Embodiments are described herein with reference to an original document in the Portable Document Format (PDF) that is ingested into the publishing system 130. However, the format of the original document is not limited to PDF; other unstructured document formats can also be reconstructed into a markup language format by a similar process.

A PDF page contains one or more content earns, which include a sequence of objects, such as path objects, text objects, and external objects. A path object describes vector graphics made up of lines, rectangles, and curves. Path can be stroked or filled with colors and patterns as specified by the operators at the end of the path object. A text object comprises character stings identifying sequences of glyphs to be drawn on the page. The text object also specifies the encodings and fonts for the character strings. An external object XObject defines an outside resource, such as a raster image in PEG format. An XObject of an image contains image properties and an associated stream of the image data.

During image extraction 301, graphical objects within a page are identified and their respective regions and bounding boxes are determined. For example, a path object in a PDF page may include multiple path construction operators that describe vector graphics made up of lines, rectangles, and curves. Metadata associated with each of the images in the document page is extracted, such as resolutions, positions, and captions of the images. Resolution of an image is often measured by horizontal and vertical pixel counts in the image; higher resolution means more image details. The image extraction process may extract the image in the original resolution as well as other resolutions targeting different eReading devices and applications. For example, a large XVGA image can be extracted and down sampled to QVGA size for a device with QVGA display. The position information of each image may also be determined. The position formation of the images can be used to provide page fidelity when rendering the document pages in eReading browser applications, especially for complex documents containing multiple images per page. A caption associated with each image that defines the content of the image may also be extracted by searching for key words, such as “Picture”, “Image”, and “Tables”, from text around the image in the original page. The extracted image metadata for the page may be stored to the overall document metadata and indexed by the page number.

Image extraction 301 may also extract tables, comprising graphics (horizontal and vertical lines), text rows, and/or text columns. The lines forming the tables can be extracted and stored separately from the rows and columns of the text.

The image extraction process may be repeated for all the pages in the ingested document until all images in each page are identified and extracted. At the end of the process, an image map that includes all graphics, images, tables and other graphic elements of the document is generated for the eReading platform.

During text extraction 302, text and embedded fonts are extracted from the original document and the location of the text elements on each page are identified.

Text is extracted from the pages of the original document tagged as having text. The text extraction may be done at the individual character level, together with markers separating words, lines, and paragraphs. The extracted text characters and glyphs are represented by the Unicode character mapping determined for each. The position of each character is identified by its horizontal and vertical locations within a page. For example, if an original page is in A4 standard size, the location of a character on the page can be defined by its X and Y location relative to the A4 page dimensions. in one embodiment, text extraction is performed on a page-by-page basis. Embedded fonts may also be extracted from the original document, which are stored and referenced by client devices for rendering the text content.

The pages in the original document having text are tagged as having text. in one embodiment, all the pages with one or more text objects in the original document are tagged. Alternatively, only the pages without any embedded text are marked.

The output of text extraction 302, therefore, a dataset referenced by the page number, comprising the characters and glyphs in a Unicode character mapping with associated location information and embedded fonts used in the original document.

Text coalescing 303 coalesces the text characters previously extracted. In one embodiment, the extracted text characters are coalesced into words, words into lines, lines into paragraphs, and paragraphs into bounding boxes and regions. These steps leverage the known attributes about extracted text in each page, such as information on the text position within the page, text direction (e.g., left to right, or top to bottom) font type (e.g., Arial or Courier), font style (e.g., bold or italic), expected spacing between characters based on font type and style, and other graphics state parameters of the pages.

In one embodiment, text coalescence into words is performed based on spacing. The spacing between adjacent characters is analyzed and compared to the expected character spacing based on the known text direction, font type, style, and size, as well as other graphics state parameters, such as character-spacing and zoom level. Despite different rendering engines adopted by the browser applications 170, the average spacing between adjacent characters within a word is smaller than the spacing between adjacent words. For example, a string of “Berriesaregood” represents extracted characters without considering spacing information. Once taking the spacing into consideration, the same string becomes “Berries are good,” in which the average character spacing within a word is smaller than the spacing between words.

Additionally or alternatively, extracted text characters may be assembled into words based on semantics. For example, the string of “Berriesaregood” may be input to a semantic analysis tool, which snatches the string to dictionary entries or Internet search terms, and outputs the longest match found within the string. The outcome of this process is a semantically meaningful string of “Berries are good.” In one embodiment, the sane text is analyzed by both spacing and semantics, so that word grouping results may be verified and enhanced.

Words may be assembled into lines by determining an end point of each line of text. Based on the text direction, the horizontal spacing between words may be computed and averaged. The end point may have word spacing larger than the average spacing between words. For example, in a two-column page, the end of the line of the first column may be identified based on it having a spacing value much larger than the average word spacing within the column. On a single column page, the end of the line may be identified by the space after a word extending to the side of the page or bounding box.

After determining the end point of each line, lines may be assembled into paragraphs. Based on the text direction, the average vertical spacing between consecutive lines can be computed. The end of the paragraph may have a vertical spacing that is larger than the average. Additionally or alternatively, semantic analysis may be applied to relate syntactic structures of phrases and sentences, so that meaningful paragraphs can be formed.

The identified paragraphs may be assembled into bounding boxes or regions. In one embodiment, the paragraphs may be analyzed based on lexical rules associated with the corresponding language of the text. A semantic analyzer may be executed to identify punctuation at the beginning or end of a paragraph. For example, a paragraph may be expected to end with a period. If the end of a paragraph does not have a period, the paragraph may continue either on a next column or a next page. The syntactic structures of the paragraphs may be analyzed to determine the text flow from one paragraph to the next, and may combine two or more paragraphs based on the syntactic structure. If multiple combinations of the paragraphs are possible, reference may be made to an external lexical database, such as WORDNET®, to determine which paragraphs are semantically similar.

In fonts mapping 304, in one embodiment, a Unicode character mapping for each glyph in a document to be reconstructed is determined. The mapping ensures that no two glyphs are mapped to a same Unicode character. To achieve this goal, a set of rules is defined and followed, including applying the Unicode mapping found in the embedded font file; determining the Unicode mapping by looking up postscript character names in a standard table, such as a system TrueType font dictionary; and determining the Unicode mapping by looking for patterns, such as hex codes, postscript name variants, and ligature notations.

For those glyphs or symbols that cannot be mapped by following the above rules, pattern recognition techniques may be applied on the rendered font to identify Unicode characters. If pattern recognition is still unsuccessful, the unrecognized characters may be mapped into the private use area (PUA) of Unicode. In this case, the semantics of the characters are not identified, but the encoding uniqueness is guaranteed. As such, rendering ensures fidelity to the original document.

In table of contents optimization 305, content of the reconstructed document is indexed. In one embodiment, the indexed content is aggregated into a document-specific table of contents that describes the structure of the document at the page level. For example, when converting printed publications into electronic documents with preservation of page fidelity, it may be desirable to keep the digital page numbering consistent with the numbering of the original document pages.

The table of contents may be optimized at different levels of the table. At the primary level, the chapter headings within the original document, such as headings for a preface, chapter numbers, chapter titles, an appendix, and a glossary may be indexed. A chapter heading may be found based on the spacing between chapters. Alternatively, a chapter heading may be found based on the font face, including font type, style, weight, or size. For example, the headings may have a font face that is different from the font face used throughout the rest of the document. After identifying the headings, the number of the page on which each heading is located is retrieved.

At a secondary level, sub-chapter headings within the original document may be identified, such as dedications and acknowledgments, section titles, image captions, and table titles. Vertical spacing between sections, text, and/or font face may be used to segment each chapter. For example, each chapter may be parsed to identify all occurrences of the sub-chapter heading font face, and determine the page number associated with each identified sub-chapter heading.

### Textbook Solutions

One particular type of document distributed by the educational platform is textbook solutions. Textbook solutions are electronic documents that provide solutions to recall-based activities associated with or included in foundation documents, such as problems, quizzes, and other types of testing activities. Textbook solutions may be provided by a publisher of the corresponding textbook, by third-party publishers, by users of the corresponding textbook (including teachers, students, tutors, etc.), or other users of the education platform. Each textbook solutions document is associated with a foundation document (which is in an electronic format, a print format, or both), and may be associated with a particular section of the foundation document, such as a chapter of the document. Thus, a given textbook or section of a textbook may be associated with multiple textbook solutions documents, and a given textbook solutions document may be associated with multiple textbooks. In one embodiment, the textbook solutions documents are indexed to locations in the corresponding textbooks and therefore in some cases may be delivered as a supplemental layer associated with the corresponding electronic textbook foundation document. In other cases, the textbook solutions documents are stand-alone documents configured to be accessed outside the context of the corresponding foundation document. For example, a user reading a print textbook can access a standalone electronic solutions document associated with the textbook through the education platform. Furthermore, while described herein as a supplemental document associated with a textbook, similar solutions documents ay be associated with other types of foundation documents, such as trade books or study guides.

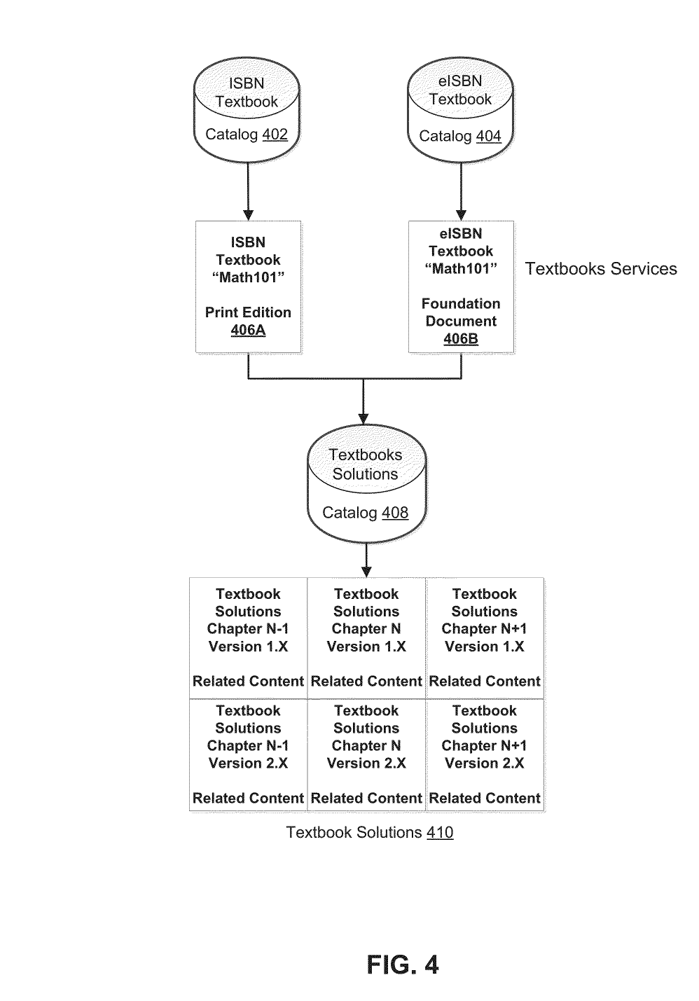

An example set of textbook solutions is illustrated in FIG. 4. As shown in FIG. 4, one embodiment of the educational platform maintains a catalog 402 of ISBN numbers of printed textbooks and a catalog 404 of &ISBN numbers of electronic textbooks. For a given textbook in the catalogs 402 and/or 404 (e.g., the print and electronic editions 406A and 406B of “Math 101”), the educational platform maintains a textbook solutions catalog 408. The textbook solutions catalog 408 includes references to a number of textbook solutions 410 associated with the textbook (e.g., the print and electronic editions 406A and 406B of “Math 101”). In the example illustrated in FIG, 4, the textbook solutions 410 include two textbook solutions versions associated with each chapter of the “Math 101” textbook. However, additional or fewer versions of solutions may be associated with each section of a textbook, and the solutions documents may each correspond to an entire textbook, a chapter of the textbook, a group of chapters, sub-chapters of the textbook, or other sections of the textbook.

In contrast to the foundation documents with which textbook solutions are associated, which are published every few years and are relatively static between publications, textbook solutions documents are edited and published frequently. Due to the dynamic nature of textbook solutions, the education platform in one embodiment provides registered users with access to textbook solutions via a subscription to a library of textbook solutions documents. Users who subscribe to textbook solutions can access textbook solutions from the library, including one or more sets of textbook solutions documents associated with each of a plurality of textbooks.

### Knowledge Proximity Detector

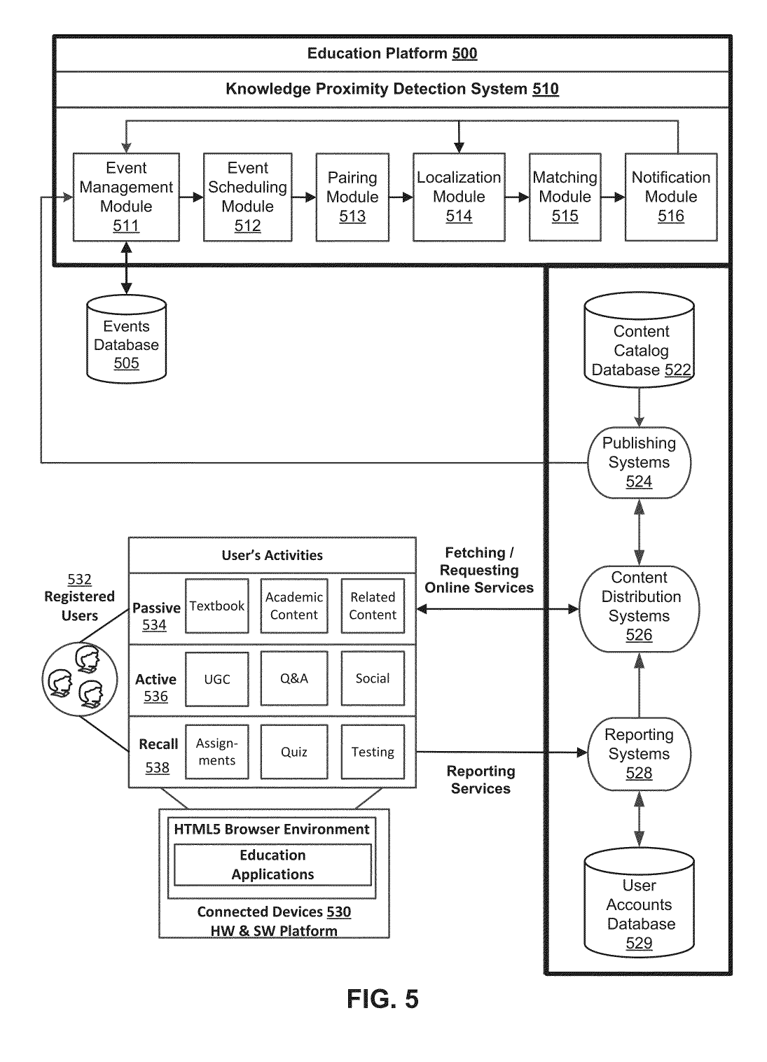

As registered users interact with textbook solutions, they may encounter unknown topics, unfamiliar methods for solving problems, or other material they have questions about. To help users seeking assistance with textbook solutions, the education platform matches the users to other users of the platform who are willing to provide assistance. FIG. 5 illustrates an education platform 500 including a knowledge proximity detector system 510, according to one embodiment. In some embodiments, the knowledge proximity detector systems 510 are integrated as part of the platform environment 100 illustrated in FIG. 1, and in other embodiments they are separate systems. Likewise, the education platform 500 may have components in common with the functional blocks of the platform environment 100, and the HTML5 browser environment 530 may be the same as the eReading application 170 of the experience block 104 of the platform environment 100 or the functionality may be implemented in different systems or modules.

The education platform 500 serves education services to registered users 532 based on a process of requesting and fetching on-line services in the context of authenticated on-line sessions. In the example illustrated in FIG. 5, the education platform 500 includes a content catalog database 522, publishing systems 524, content distribution systems 526, reporting systems 528, and user accounts database 529. The content catalog database 522 contains the collection of content available via the education platform 522. In one embodiment, the content catalog database 522 includes the ISBN textbook catalog 402, the eISBN textbook catalog 404, and the textbook solutions catalog 408 described with respect to FIG. 4. The content catalog database 522 feeds the content to the publishing systems 524. The publishing systems 524 serve the content to registered users 532 via the content distribution system 526. The reporting systems 528 receive reports of user experience and user activities from the connected devices 530 operated by the registered users 532. This feedback is used by the content distribution systems 526 for managing the distribution of the content and for capturing user-generated content and other forms of user activities to add to the content catalog database 522.

Registered users access the content distributed by the content distribution systems 526 via browser-based education applications executing on a user device 530. In one embodiment, the education platform 500 establishes an authenticated web session on the device 530 when the user logs into a user account on the education platform 500 and/or requests to access content and services of the education platform 500 from the device 530. During the time an authenticated web session is established on the device 530, the device 530 is referred to as a “connected device.” In some cases, the education platform 500 ends the user session on the device 530 if the user is inactive (e.g., does not create or request new content) for a specified period of time, such as fifteen minutes.

As users interact with content via the connected devices 530, the reporting systems 528 receive reports about various types of user activities, broadly categorized as passive activities 534, active activities 536, and recall activities 538. Passive activities 534 include registered users' passive interactions with published academic content materials, such as reading a textbook. These activities are defined as “passive” because they are typically orchestrated by each user around multiple online reading authenticated sessions when accessing the structured HTML referenced documents. By directly handling the fetching and requesting of all HTML, course-based document pages for its registered users, the connected education platform analyzes the passive reading activities of registered users.

Activities are defined as “active” when registered users are interacting with academic documents by creating their own user generated content (user-venerated content) layer as managed by the platform services. By contrast to “passive” activities, where content is predetermined and static, the process of creating user generated contents unique to each user, both in terms of actual material, format, frequency, or structure, for example. In this instance, user-generated content is defined by the creation of personal notes, highlights, and other comments, or interacting with other registered users 532 through the education platform 500 while accessing the referenced HTML documents. Other types of user-generated content include asking questions when help is needed, solving problems associated with particular sections of course-based HTML documents, and connecting and exchanging feedback with peers, among others. These user-generated content activities are authenticated through on-line “active” sessions that are processed and correlated by the platform content distribution system 526 and reporting system 528.

Recall activities 538 test registered users against knowledge acquired from their passive and active activities. In some cases, recall activities 538 are used by instructors of educational courses for evaluating the registered users in the course, such as through homework assignments, tests, quizzes, and the like. In other cases, users complete recall activities 538 to study information learned from their passive activities, for example by using flashcards, solving problems provided in a textbook or other course materials, or accessing textbook solutions. In contrast to the passive and active sessions, recall activities can be orchestrated around combined predetermined content material with user-generated content. For example, the assignments, quizzes, and other testing materials associated with a course and its curriculum are typically predefined and offered to registered users as structured documents that are enhanced once personal content is added into them. Typically, a set of predetermined questions, aggregated by the platform 500 into digital testing material, is a structured HTML document that is published either as a stand-alone document or as supplemental to a foundation document. By contrast, the individual answers to these questions are expressed as user-generated content in some testing-like activities. When registered users are answering questions as part of a recall activity, the resulting authenticated on-line sessions are processed and correlated by the platform content distribution 526 and reporting systems 528.

The education platform aggregates records of the passive 534, active 536, and recall 538 activities completed by a user into a user account for the user, which is stored in the user accounts database 529. Each user account may also include other information about the corresponding user, including information provided by the user and information generated by the education platform 500. For example, the user may provide information about institutions in which the user is or has been enrolled, courses the user has taken, and the user's academic major. As another example, the user profile includes an effective grade point average eGPA) of the user, which quantifies the user's academic engagement and achievements based on scored, aggregated educational activities completed by the user. In one embodiment, the education platform 500 generates eGPAs by analyzing and scoring passive, active, and recall user activities on the platform 500, user-provided information, and data retrieved from external sources such as professional organizations, employers, journal publishers, or external social networking systems. Thus, eGPAs provide mechanisms for quantitatively comparing users of the education platform 500 based on a number of activities completed by the users, including coursework, professional development, and social activities. A process for generating eGPAs is described further in U.S. patent application Ser. No. 14/051,061, filed Oct. 10, 2013, which is incorporated herein by reference in its entirety.

As shown in FIG. 5, one embodiment of the education platform 500 includes a knowledge proximity detection system 510. The knowledge proximity detection system 510 enables users seeking assistance to find, contact, and arrange meetings with users willing to provide assistance. In an example use case, a user who is willing to provide academic assistance (referred to herein as a “provider”) sends an offer to the knowledge proximity detection system 510, indicating the provider's willingness to assist other users. A user seeking academic assistance (referred to herein as a “seeker”) sends a request to the knowledge proximity detection system 510 while accessing a set of textbook solutions to receive assistance with the set of textbook solutions. For example, while accessing textbook solutions via an education application executing on the connected device 530, the seeker interacts with an interface element of the education application to send a request for assistance to the knowledge proximity detection system 510. The offers and requests are provided asynchronously to the knowledge proximity detection system 510, and the same user can be both a seeker requesting help with textbook solutions and a provider offering to help other users within the same or other subjects,

For each offer and request, the knowledge proximity detection system 510 generates, respectively, an offered event and a requested event. The offered and requested events each include a data structure defining attributes of the corresponding event, and each event is associated with a specified time interval. Using the attributes of the events, the knowledge proximity detection system 510 pairs the offered events and requested events. When a seeker and provider of paired events are in geographic proximity to one another and both users agree to a connection, the knowledge proximity detection system 510 connects the seeker and the provider. The seeker and one or more of the providers can communicate through the education platform 500 to arrange a time and location to meet for an in-person academic assistance event, where the provider can assist the seeker with textbook solutions.

In one embodiment, as shown in FIG. 5, the knowledge proximity detector system 510 comprises an event management module 511, an event scheduling module 512, a pairing module 513, a localization module 514, a matching module 515, and a notification module 516, Other embodiments of the knowledge proximity detection system 510 include different, fewer, or additional modules, and the functions may be distributed differently among the modules.

The event management module 511 receives the offers and requests for academic assistance events issued by users of the education platform 500 and, in response, creates records for the offered and requested events. As the education platform 500 receives asynchronous offers and requests from users of the platform, the event management module 511 creates a record in the events database 505 for each requested or offered event that includes attributes of the corresponding event. Some event attributes are automatically captured by the event management module 511 when a user requests or offers an event, while other attributes are specified by the user.

Example attributes automatically associated with the offered event by the event management module 511 include an identifier of the provider, the time the provider offered the event, and status of the event (e.g., open or closed). The event management module 511 also captures a reference to a set of textbook solutions for which the provider is willing to provide assistance. In some cases, the provider specifies foundation documents (or sections of the foundation documents) for which the provider is willing to provide assistance, and the event management module 511 associates the offer with any textbook solutions associated with the specified foundation documents (or specified sections of foundation documents). In another case, the event management module 511 automatically associates the offer with textbook solutions documents the provider has accessed.

Another attribute of an offered event captured by the event management module is a time interval over which the provider is willing to provide assistance. The time interval for the offered event includes a range of dates the provider is available to provide assistance, such as January 1 through May 31, or August 1 until the provider closes the offer. The time interval may further specify times the provider is available during the range of dates. For example, a provider may specify he is only available certain days of the week or certain times of day.

Yet another attribute that may be associated with an offered event is a distance the provider is willing to travel to meet with a seeker (referred to herein as the provider's “proximity threshold”). The proximity threshold defines a geographic area determined to be in proximity to the provider. An example proximity threshold of one mile indicates that the provider is willing to meet with a seeker if the seeker is less than one mile away, and a seeker is in proximity to the provider if the seeker is within the one mil threshold.

In one embodiment, the event management module 511 also associates the offered event with attributes of the provider. One of the provider attributes associated with the offered event may be a privacy setting of the provider, indicating how much information about the provider can be displayed to seekers. For example, privacy settings may indicate whether the provider's full name is shown to seekers or whether a picture of the provider is shown to seekers. The provider's privacy settings may also request particular pieces of information from seekers before the provider will meet with the seeker. For example, a provider may specify that he will only meet with seekers whose user profiles are public. Another attribute of the provider associated with the offered event may be preferred communication media of the provide. (e.g., email, SMS, or push notifications), indicating how the provider prefers to be contacted if a seeker is nearby. Other attributes of the provider associated with the offered event include, for example, textbook solutions the provider has accessed, a date the provider last accessed each solutions documents, courses the provider has taken, or the provider's academic GPA or eGPA.

In a similar manner, the event management module 511 associates requested events with various attributes, such as an identifier of the user requesting the event, the time the request was created, status of the requested event, the seeker's privacy settings, and/or the seeker's preferred communication media. The event management module 511 also associates the requested event with one or more sets of textbook solutions. In particular, the event management module 511 identifies a textbook solutions document the seeker was accessing when the request was placed. The event management module 511 may associate the requested event with an identifier of the particular textbook solutions document the seeker was accessing, or may associate the request with the foundation document or section of a foundation document corresponding to the textbook solutions. The seeker may also specify other attributes of the requested event, such as an indicator of the complexity of the seeker's questions or a priority of the request. The priority of the request is a qualitative assessment of the request's importance to the seeker. For example, a seeker who is preparing for a final examination may set the priority of a request to “high,” while a seeker who is merely curious about a topic may set the priority of a request to “low.”

Another attribute that may be associated with the requested event is a time window during which the seeker is requesting assistance. The time window for a requested event is often shorter than the time window for an offered event. For example, if the seeker is preparing for an upcoming examination, the seeker may set the time of the examination as the end of the time window for the academic assistance event.

Yet another attribute associated with the requested event is a proximity threshold for the seeker. Similar to the proximity threshold for the provider, the seeker's proximity threshold specifies a distance the user is witting to travel to meet with a provider, defining a geographic area considered to be in proximity to the seeker. In one embodiment, the event management module 511 increases the proximity threshold for an event as the end of the event window approaches. For example, as the end of the event window approaches, the seeker may be willing to travel a longer distance to meet with a provider. Thus, the event management module 511 increases the proximity threshold by an inverse function of the amount of time remaining in the event window. The increase may be linear, exponential, step-wise, or any other relationship to the amount of time remaining in the event window. In some cases, the function used to recalculate the proximity threshold may be selected based on the priority of the seeker's request, where the proximity threshold for higher-priority requests is increased at a faster rate than the proximity threshold for lower-priority requests. By increasing the proximity threshold for an open event near the end of the event window, the event management module increases the chances for finding a suitable provider to assist the seeker.

Still other attributes may additionally or alternatively be associated with each requested or offered event, such as compensation for the event.

The event scheduling module 512 schedules the offered and requested events. To schedule an event, the event scheduling module 512 enqueues the event for matching to other events during the time window specified for the event.

The pairing module 513 pairs requested and offered events based on the event attributes of respective events. In one embodiment, the pairing module 513 generates initial pairings based on the type of event (requested or offered), the textbook solutions document referenced by the event, and the time interval specified for the event. In particular, the pairing module 513 pairs a requested event to one or more offered events when the requested and offered events reference the same or similar textbook solutions documents and the time intervals for the requested and offered events overlap at least in part. For example, a requested and offered event reference similar solutions documents if the solutions documents are associated with the same foundation document or section of a foundation document. To determine if the time intervals for the requested and offered events overlap, the pairing module 513 determines the intersection of the time interval specified for the requested event and the time interval specified for the offered event. If the intersection is non-zero (that is, if there is an overlap between the starting and ending times of a requested event and the starting and ending times of an offered event), the pairing module 513 pairs the requested and offered events.

In one embodiment, the pairing module 513 assigns a score to each event pairing, indicating the degree of matching between the paired events. For example, the score may be based on the length of overlap between the time intervals specified for each event, the degree to which the seeker's and provider's privacy settings match, or other factors.

In one embodiment, the pairing module 513 generates a score for a pair of events by scoring the provider of the offered event paired to the seeker's requested event. In one embodiment, the pairing module 513 generates the score based on the attributes of the requested event, the offered event, and the respective users. Thus, a provider's score when paired to a first seeker may be different from the provider's score when paired to a second seeker. Attributes used by the pairing module 513 to score each pairing include, for example, privacy settings of the users, eGPA of the provider, creation date of the provider's offer, an amount of time since the provider has accessed the set of textbook solutions for which the seeker is requesting assistance, the provider's major of study, a number of requests for assistance events placed by the seeker or provider, a number of times the provider or seeker has offered assistance to another user, or a number of common social network connections shared by the seeker and provider. For example, a provider with a high eGPA receives a higher score than a provider with a lower eGPA, and a provider who earned a higher grade in a course corresponding to the textbook solutions for which the seeker is requesting assistance receives a higher score than a provider who received a lower grade in the course. A provider who more recently accessed the textbook solutions for which the seeker is requesting assistance receives a higher score than a provider who accessed the textbook solutions less recently. Similarly, a provider who more recently took a course using the textbook solutions receives a higher score than a provider who took the course less recently. Providers may also be scored based on their privacy settings or the seeker's privacy settings. For example, a seeker's privacy settings may indicate that the seeker is unwilling to meet with a provider whose profile information remains anonymous. The possible providers for the seeker are scored based on the providers' respective privacy settings, where providers having public profiles receive higher scores than providers having more private profiles. Similarly, if a provider's privacy settings indicate that the provider is unwilling to meet with a seeker whose profile information remains anonymous, the provider may receive a higher score for seekers having public profiles than for seekers having private profiles.

In one embodiment, the pairing module 513 ranks the user pairings based on the score assigned to each provider. In another embodiment, the pairing module 513 uses the scores to filter out incompatible user pairings. For example, the pairing module 513 compares the score to a threshold compatibility score. If the score for the pairing is below the threshold, the pairing module 513 does not pair the requested and offered events. Thus, in some cases, the pairing module 513 uses the score to refine the initial pairings determined based on textbook solutions and time intervals of the requested and offered events. The threshold compatibility score may be a fixed value, or may change dependent on the amount of time remaining in the scheduled window for the event. For example, as the amount of time until the seeker's deadline for receiving assistance decreases, the pairing module 513 may decrease the threshold score. As the threshold score decreases, new providers not previously paired to the seeker due to their scores falling below the original threshold may be paired to the seeker.

The localization module 514 tracks locations of the seeker and provider of a paired academic assistance event to identify when the seeker and provider of a pair are in proximity to one another. The localization module 514 determines locations of the users based on IP address of the users' connected devices, global positioning of the users' devices, nearby WiFi connections, nearby cellular towers, or the like. In one embodiment, the localization module 514 only tracks user locations when the users are logged into the education platform 500 through connected devices 530 and have granted permission for the localization module 514 to track their locations.

Using the locations of the users provided by the localization module 514, the matching module 515 determines whether the seeker and provider of a scheduled academic assistance event are in proximity to one another. To detect proximity, the matching module 515 compares the users' locations to the proximity threshold set by one or both of the users. In one embodiment, the matching module 515 determines the users to be in proximity to one another if the distance between the users is less than the seeker's proximity threshold. In another embodiment, the matching module 515 determines the users to be in proximity to one another if the distance between the users is less than the smaller of the seeker's and provider's proximity thresholds. For example, the seeker of an academic assistance event sets a proximity threshold of 5 miles, specifying that the seeker is willing to meet with a provider if the provider is less than 5 miles away. The provider sets a proximity threshold of 2 miles, specifying that the provider is willing to meet with the seeker if the seeker is less than 2 miles away. The matching module 515 does not determine the users to be in proximity to one another if the distance between the seeker and provider is 4 miles, but does determine the users to be in proximity if the distance between the users is 1 mile. In yet another embodiment, the matching module 515 determines the users to be in proximity to one another if the distance between the users is less than either of the proximity thresholds. In the example provided above, the matching module 515 determines the users to be in proximity to one another when the distance between them is 4 miles, since 4 miles is within the seeker's (proximity threshold of 5 miles. In still another embodiment, the (proximity threshold specifies a distance the users are willing to travel to meet, and the matching module 515 determines the users to be in proximity to one another when half of the distance between them is less than the two proximity thresholds.

If multiple providers are in proximity to a seeker, one embodiment of the matching module 515 selects a provider for matching to the seeker based on the score assigned to the provider by the pairing module 513. For example, if the seeker is in proximity to two providers, the matching module 515 matches the seeker to the provider having the higher score. In another embodiment, the matching module 515 selects the provider closest to the seeker for matching to the seeker. In a still further embodiment, the matching module 515 matches the seeker to a provider based on a function of both the distance between the seeker and each provider and the score assigned to the seeker-provider pairing by the pairing module 513.

When the matching module 515 matches the seeker to a provider, the notification module 516 notifies the seeker and provider of their proximity to one another. In one embodiment, the notification module 516 generates notifications based on the privacy settings of the seeker and provider. For a user profile having a privacy setting of “public,” the notification module 516 generates a notification including information about the corresponding user, such as the user's full name, school or course affiliation, a picture of the user, and/or other user information. For a user profile having a setting of “private,” the notification module 516 generates a notification with little or no identifying information. For example, the notification indicates only a textbook solutions document for which the seeker is requesting assistance, only a first name of the user, or the like.

The notification module 516 sends the notifications to the seeker and provider via the seeker's and provider's preferred communication media to indicate that the other user is in proximity. For example, the notification module 516 sends the seeker and provider information about an approximate location of the other user and, depending on the users' privacy settings, a summary of the other user's attributes, such as the user's name, picture, school affiliation, and eGPA. In one embodiment, the notification requests the provider or seeker, or both, to confirm the academic assistance event. By confirming an academic assistance event, the provider and seeker confirm their willingness to meet with one another.

If the meeting is confirmed, the notification module 516 enables communication between the seeker and provider. In one embodiment, the notification module 516 enables communication through the education platform 500 (e.g., via instant messaging, email, or other types of electronic communication). For example, the notification module 516 sends the seeker and provider a link to a collaborative learning space provided by the educational platform 500, where the users can communicate with one another, share educational content references, and so forth. In another embodiment, the notification module 516 sends the seeker and provider a phone number, email address, or other contact information for the other user. The seeker and provider can then communicate through the education platform 500 or via an external communications system to arrange a place and time to meet, where the provider can assist the seeker with textbook solutions.

### Knowledge Proximity Detection Process

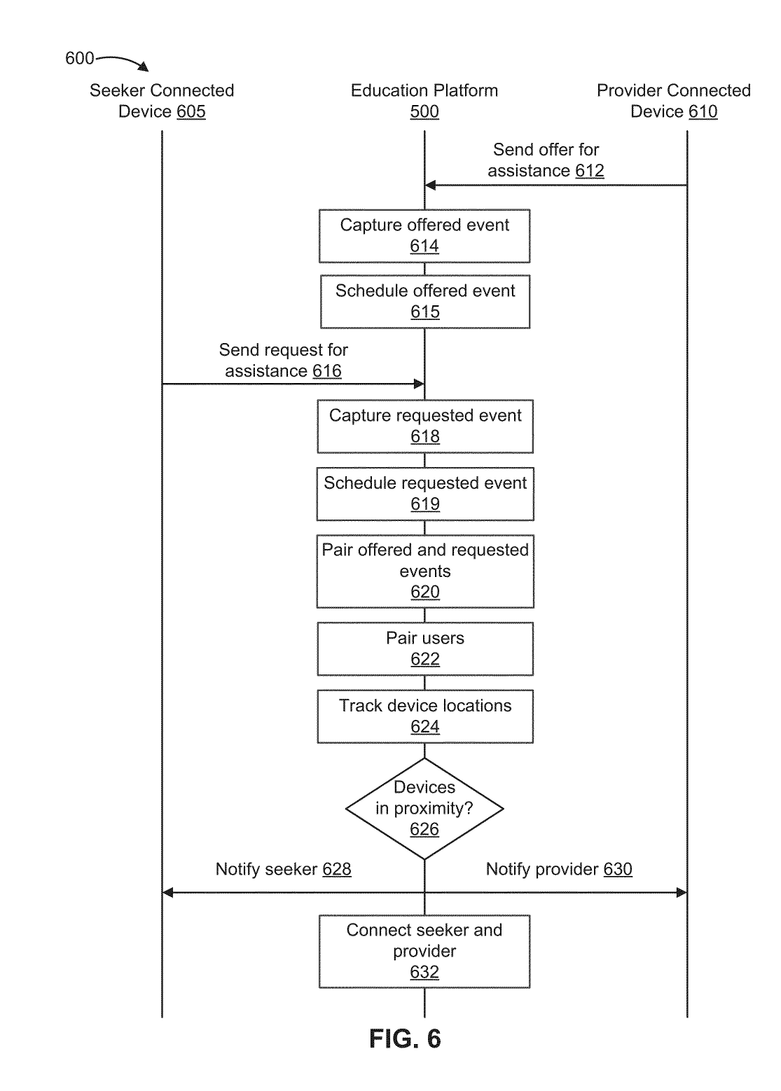

FIG. 6 illustrates a process 600 for matching users for academic assistance events, according to one embodiment. In one embodiment, the process 600 comprises interactions between the education platform 500, a connected device 605 of a seeker, and a connected device 610 of a provider. Other embodiments of the process 600 may be performed by different entities, and the process 600 may include additional, fewer, or different steps. Furthermore, the steps may be performed in a different order. In FIG. 6, time flows from top to bottom of the diagram and horizontal arrows between entities represent communications.

The education platform 500 receives offers for academic assistance events from a plurality of registered users. For each offer, a user of the education platform who has accessed textbook solutions uses the connected device 610 to send 612 the offer to the education platform 500. When sending the offer, the provider may provide additional information about the offered event, such as the textbook solutions for which the user is willing to provide assistance, a time period over which the user is available to offer assistance, a proximity threshold, prefer e notification media, privacy settings, or other information.

The education platform 500 captures 614 the offered event and generates a record for the event in the events database 505. The education platform 500 associates the information given by the provider with the event record as attributes of the event. Based on the user session open on the connected device 610 when the provider offers the event, the education platform 500 captures other attributes of the event, such as the time the offer was created and an identifier of the user offering the event. Furthermore, the education platform 500 may retrieve information about the provider based on the user identifier, such as the provider's eGPA, courses taken by the provider, and/or textbook solutions accessed by the provider, and associate the user information with the offered event as additional attributes. The education platform 500 schedules 615 the offered event for the time period specified by the provider.

A second user of the education platform 500 who is accessing textbook solutions uses the connected device 605 to send 616 a time-sensitive request for an academic assistance event to the education platform 500. For example, a student studying a set of textbook solutions desires an academic assistance event in which another user can explain the solutions, provide further information about a problem or a solution, explain concepts behind the textbook solutions, or provide other assistance associated with the set of textbook solutions. The seeker's request may be time-sensitive, for example if the seeker is studying for an upcoming examination or completing a homework assignment. That is, the seeker desires assistance within a window of time preceding the date of the examination or the due date of the assignment, and the seeker's request becomes obsolete after the date has passed. When sending the request, the seeker may provide additional information about the requested event, such as the time period during which the seeker is seeking assistance, a proximity threshold, preferred notification media, privacy settings, an indicator of complexity of the seeker's request, or other information.

The education platform 500 captures 618 the requested event and generates a record for the event in the events database 505. The education platform 500 associates the information provided by the seeker with the event record as attributes of the event. Based on the user session open on the connected device 605 when the seeker requested the event, the education platform 500 captures other attributes of the event, such as an identifier of the user requesting the event, an identifier of the textbook solutions document the seeker was accessing when the request was placed, and the time the request was placed. The education platform 500 schedules 619 the requested event for the time period specified by the seeker.

The education platform 500 pairs 620 the requested event to one or more offered events based on the attributes of the requested event and the offered events, including the textbook solutions referenced by the event and the time window specified for the event. For example, an offered event is paired to the requested event if the offered event and requested event are associated with the same set of textbook solutions and the time window for both events at least partially overlaps. By pairing offered events to the requested event based on textbook solutions the providers have accessed, the education platform 500 selects users with relevant academic knowledge to assist the seeker. The education platform 500 may also use other attributes of the requested and offered events to pair the events.

The education platform pairs 622 the users associated with the paired events. Users may be paired based on the user-specified attributes of the events, user profile information of the users, or other information. In one embodiment, the education platform 500 determines a score for the providers of each offered event paired to the seeker's requested event. If multiple seeker-provider pairings are possible based on the event pairing in step 620, the education platform 500 may rank the possible seeker-provider pairings using the determine scores. In other cases, the education platform 500 removes a seeker-provider pairing from the set of possible pairings if the score for the pairing is below a predefined threshold.

During the event window, the education platform 500 determines whether the requested event is open and, if so, tracks 624 the locations of the seeker's connected device 605 and the provider's connected device 610. As the seeker and provider are likely to change locations throughout the window scheduled for the event, the education platform 500 may periodically (e.g., every 10 minutes) query the locations of the connected devices 605, 610. In one embodiment, the education platform 500 retrieves the device locations when user sessions with the education platform 500 are active on the devices 605, 610. It is noted that although the seeker and provider are logged into the education platform 500 during location tracking, they need not be accessing the same content within the platform. For example, one user could be reading a textbook while the other user is communicating with social network connections through the platform. Furthermore, if a user recently accessed the education platform 500, a user session may be active on the user's device even if the user is not actively interacting with the platform.

The education platform 500 compares the distance between the devices 605, 610 to proximity thresholds set by the seeker and provider to determine 626 whether the devices are in proximity to one another. The education platform 500 tracks 624 the device locations until a device of a seeker is determined to be in proximity to a device of a paired provider or the event is closed.

If the devices 605, 610 are determined 626 to be in proximity to one another, the education platform 500 notifies 628, 630 the seeker and provider. In one embodiment, the education platform 500 notifies 630 the provider by sending a notification to the provider's connected device 610, indicating that a user seeking assistance for a particular set of textbook solutions is in the vicinity. The notification may include the seeker's location, the distance between the seeker and the provider, profile information of the seeker, or other information, depending on the privacy settings of the seeker. If the provider confirms the assistance event, the education platform 500 notifies 628 the seeker that the provider is nearby and willing to offer assistance. In another embodiment, the education platform 500 notifies 628 the seeker by sending a notification to the seeker's connected device 605, indicating that a user providing assistance for the requested set of textbook solutions is in the vicinity. The notification may include the provider's location, the distance between the seeker and the provider, profile information of the provider, or other information, depending on the privacy settings of the provider. if the seeker confirms the assistance event, the education platform 500 notifies 630 the provider that the seeker is nearby and seeking assistance.

Responsive to the users confirming the assistance event, the education platform 500 connects 632 the seeker and provider. In one embodiment, the education platform 500 connects the seeker and provider by sending the users a link to a private communication site, such as a chat room or a shared whiteboarding space. The users can communicate through the platform to arrange a location to meet, share academic materials, or the like. In other embodiments, the education platform 500 sends one or both users contact information for the other user, such as a phone number, email address, or contact information on an external social network. In other cases, depending on the privacy settings of the users, the education platform 500 sends the seeker and provider a picture of the other user to help the users identify each other when meeting. The seeker can meet with the provider and receive assistance with the textbook solutions.

In one embodiment, the education platform 500 closes the requested event after connecting the seeker and provider. Alternatively, the seeker may close the requested event after meeting with the provider. Furthermore, the education platform 500 may close the requested event and the offered event at the end of the event window of the respective events. By closing an event, the education platform 500 ends location tracking for the devices 605 and 610.

If the seeker or provider does not confirm the assistance event, the education platform 500 continues tracking the location of the seeker and potential providers until another provider is determined to be in proximity to the seeker or until the end of the time period for the requested event. In one embodiment, the education platform 500 increases the seeker's proximity threshold as the end of the event window approaches to increase the probability of a provider being in proximity to the seeker.

The knowledge proximity detection system as described herein enables students to seek academic assistance from peers based on proximity to one another and relevant academic knowledge, outside the rigid instructional framework of traditional courses. Any user of the education platform can be both a seeker and a provider, requesting assistance with some sets of textbook solutions and providing assistance for others. Furthermore, rather than meeting with a tutor for a particular course at a designated time and place, users of the education platform 500 who are seeking time-sensitive assistance with textbook solutions can locate and meet with other users of the platform whenever the users are in proximity to one another and regardless of the users' course or institutional affiliations. Thus, users can receive help with textbook solutions when needed and regardless of their location, whether on a college campus, in a coffee shop, or walking through a shopping mall.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, white described functionally or logically, are understood to be implemented by computer programs. Furthermore, it has also proven convenient at times, to refer to these arrangements of operations as modules or by functional names, without loss of generality,

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that ca. be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that variety of programming languages may be used to implement the teachings of the present invention as described herein, and any references to specific languages, such as HTML or HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, hat not limiting, of the scope of the invention.

What is claimed is:

1. A method fir matching users for academic assistance events in an online education platform, the method comprising:
receiving at the education platform, offers for academic assistance events from each of a plurality of providers, each provider a registered user of the education platform who has accessed one or more textbook solutions documents;
capturing a time-sensitive request for an academic assistance event from a seeker, the request associated with a textbook solutions document;
pairing, by the education platform, the requested event to at least one offered event based on the textbook solutions associated with the requested event and the textbook solutions accessed by the providers;
detecting proximity of the seeker and the provider of the at least one offered event during an event window corresponding to the paired events;
notifying the seeker and the provider of the at least one offered event of the detected proximity; and
responsive to receiving confirmation of the paired events, connecting the seeker and the provider of the at least one offered event through the education platform, the connection enabling communication between the seeker and the provider.

2. The method of claim 1, further comprising:
identifying a textbook corresponding to the textbook solutions document associated with the request; and
associating the request with a plurality of textbook solutions documents mapped to the identified textbook;
wherein pairing the requested event to the at least one offered event comprises identifying a provider who has accessed one or more of the textbook solutions documents mapped to the identified textbook.

3. The method of claim 1, further comprising:
identifying a section of a textbook corresponding to the textbook solutions document associated with the request; and
associating the request with a plurality of textbook solutions documents mapped to the identified textbook section;
wherein pairing the requested event to the at least one offered event comprises identifying a provider who has accessed one or more of the textbook solutions documents mapped to the identified textbook section.

4. The method of claim 1, wherein pairing the requested event to the at least one offered event comprises:
ranking the provider; and
selecting one or more of the offered events to pair to the requested event using the rankings of the providers.

5. The method of claim 4, wherein the providers are ranked based on at least one of academic credentials of the providers, an amount of time since the providers last accessed a textbook solutions document, and privacy settings of the providers.

6. The method of claim 1, further comprising:
identifying locations of the seeker and the provider of the at least one offered event during the event window;
wherein the proximity of the seeker and the provider of the at least one offered event is detected responsive to a distance between the location of the seeker and the location of the provider of the at least one offered event being less than a proximity threshold.

7. The method of claim 6, wherein the locations of the seeker and the provider of the at least one offered event are identified based on one selected from the group consisting of an IP address, global positioning, wireless network triangulation, and cellular tower triangulation.

8. The method of claim 6, further comprising increasing the proximity threshold during the event window for the paired events.

9. The method of claim 1, wherein connecting the seeker and the provider of the at least one offered event comprises:
sending the seeker and the provider of the at least one offered event a time-based link to a shared digital space.

10. The method of claim 1, wherein the confirmation of the paired event is received from the provider of the at least one offered event, and wherein the method further comprises:
notifying the seeker of the proximity of the provider responsive to receiving the confirmation from the provider of the at least one offered event.

11. The method of claim 1, wherein the confirmation of the paired event is received from the seeker, and wherein the method further comprises:
notifying the provider of the at least one offered event of the proximity of the seeker responsive to receiving the confirmation from the seeker.

12. A non-transitory computer readable storage medium storing computer program instructions for matching users for academic assistance events in an online education platform, the computer program instructions comprising instructions for:
receiving offers for academic assistance events from each of a plurality of providers, each provider a registered user of the education platform who has accessed one or more textbook solutions documents;
capturing a time-sensitive request for an academic assistance event from a seeker, the request associated with a textbook solutions document;
pairing the requested event to at least one offered event based on the textbook solutions associated with the requested event and the textbook solutions accessed by the providers;
detecting proximity of the seeker and the provider of the at least one offered event during an event window corresponding to the paired events;
notifying the seeker and the provider of the at least one offered event of the detected proximity; and
responsive to receiving confirmation of the paired events, connecting the seeker and the provider of the at least one offered event through the online education platform, the connection enabling communication between the seeker and the provider.

13. The non-transitory computer readable storage medium of claim 12, the computer program instructions further comprising instructions for:
identifying a textbook corresponding to the textbook solutions document associated with the request; and
associating the request with a plurality of textbook solutions documents mapped to the identified textbook;
wherein the computer program instructions for pairing the requested event to the at least one offered event comprise instructions for identifying a provider who has accessed one or more of the textbook solutions documents mapped to the identified textbook.

14. The non-transitory computer readable storage medium of claim 12, the computer program instructions further comprising instructions for:
identifying a section of a textbook corresponding to the textbook solutions document associated with the request; and
associating the request with a plurality of textbook solutions documents mapped to the identified textbook section;
wherein pairing the requested event to the at least one offered event comprises identifying a provider who has accessed one or more of the textbook solutions documents mapped to the identified textbook section.

15. The non-transitory computer readable storage medium of claim 12, wherein the computer program instructions fur pairing the requested event to the at least one offered event comprise instructions tor:
ranking the provider; and
selecting one or more of the offered events to pair to the requested event using the rankings of the providers.

16. The non-transitory computer readable storage medium of claim 12, the computer program instructions further comprising instructions for:
identifying locations of the seeker and the provider of the at least one offered event during the event window;
wherein the proximity of the seeker and the provider of the at least one offered event is detected responsive to a distance between the location of the seeker and the location of the provider of the at least one offered event being less than a proximity threshold.

17. The non-transitory computer readable storage medium of claim 16, the computer program instructions further comprising instructions for increasing the proximity threshold. during the event window for the paired events.

18. The non-transitory computer readable storage medium of claim 12, the computer program instructions connecting the seeker and the provider of the at least one offered event further comprising instructions for:
sending the seeker and the provider of the at least one offered event a time-based link to a shared digital space.

19. The non-transitory computer readable storage medium of claim 12, wherein the confirmation of the paired event is received from the provider of the at least one offered event, and wherein the computer program instructions further comprise instructions for:
notifying the seeker of the proximity of the provider responsive to receiving the confirmation from the provider of the at least one offered event.

20. The non-transitory computer readable storage medium of claim 12, wherein the confirmation of the paired event is received from the seeker, and wherein the computer program instructions further comprise instructions for:
notifying the provider of the at least one offered event of the proximity of the seeker responsive to receiving the confirmation from the seeker.
